(19) United States
(12) Patent Application Publication
(10) Pub. No.: US 2016/0005230 A1
(43) Pub. Date: Jan. 7, 2016

(54) Server Controlled Augmented Reality

(71) Applicants: Randy Pete Asselin, Albuquerque, NM (US); David Wayne Schneider, Albuquerque, NM (US)

(72) Inventors: Randy Pete Asselin, Albuquerque, NM (US); David Wayne Schneider, Albuquerque, NM (US)

(21) Appl. No.: 14/323,173

(22) Filed: Jul. 3, 2014

(51) Int. Cl. G06T 19/00; G06F 17/30; A63F 13/35; H04L 29/06

(52) U.S. Cl. CPC G06T 19/006; H04L 67/42; G06F 17/30592; A63F 13/35

(57) ABSTRACT

The invention provides for topical, relevant content to be delivered from a central server to devices running a viewer application. The content can be customized using the current user, device, location, compass, accelerometer and date/time information. The viewer application scans for known targets using its camera, or an end-user can make a selection from a text or visual directory. Once found, the platform is notified of the target. The platform then sends the appropriately customized content and data on how to render said content to the viewer for display, which can be text, images, data, video, animation, notifications and other types of content. The platform uses a data warehouse to refine content and provide detailed analytics. The platform can provide automatic content at launch. The viewer caches data for optimal performance. The user can respond to content, which delivers analytics, and more content as appropriate.

### CROSS REFERENCE TO RELATED APPLICATIONS

NONE.

### STATEMENT REGARDING FEDERALLY SPONSORED R&D

NONE.

### NAMES OF PARTIES TO A JOINT RESEARCH AGREEMENT

NONE.

### BACKGROUND OF THE INVENTION

1. Technical Field of the Invention

2. Description of the Prior Art

U.S. patent application publication number 2014/0043426 of Nikola Bicanic et al. published Feb. 13, 2014 for SUCCESSIVE REAL-TIME INTERACTIVE VIDEO SESSIONS discloses a method for initiating continuous succession of multiple real time interactive video sessions of a predetermined duration between two users among multiple users logged on to a server through a network. The method includes matching of a set of predetermined characteristics of a first user with a set of predetermined characteristics of other users, and identifying an appropriate second user for the first user to interact with. On identifying the second user, a real time interactive session of predetermined duration is initiated between the two users and the user accounts of the two users are debited by a predetermined amount of virtual currency. On identifying a swiping operation on the display screen in a predetermined manner, by any of the first and the second users, the method automatically terminates the current video session, and initiates a next video session for that user.

This reference is deficient in the following respects: this reference is limited to only two users; is limited to video; has no backend support.

U.S. patent application number 2014/0168347 of Ann Devereaux et al published on Jun. 19, 2014 for WIRELESS AUGMENTED REALITY COMMUNICATION SYSTEM discloses a portable unit is for video communication to select a user name in a user name network. A transceiver wirelessly accesses a communication network through a wireless connection to a general purpose node coupled to the communication network. A user interface can receive user input to log on to a user name network through the communication network. The user name network has a plurality of user names, at least one of the plurality of user names is associated with a remote portable unit, logged on to the user name network and available for video communication.

This reference is deficient in the following respects: the references is limited to video; the reference is limited to only log in information

U.S. patent application publication number 2010/0208029 of Stefan Marti et al published on Aug. 19, 2010 for MOBILE IMMERSIVE DISPLAY SYSTEM discloses a mobile content delivery and display system enables a user to use a communication device, such as a cell phone or smart handset device, to view data, images, and video, make phone calls, and perform other functions, in an immersive environment while being mobile. The system, also referred to as a platform, includes a display component which may have one of numerous configurations, each providing extended field-of-views (FOVs). Display component shapes may include hemispherical, ellipsoidal, tubular, conical, pyramidal, or square/rectangular. The display component may have one or more vertical and/or horizontal cuts, each having various degrees of inclination, thereby providing the user with partial physical enclosure creating extended horizontal and/or vertical FOVs. The platform may also have one or more projectors for displaying data (e.g., text, images, or video) on the display component. Other sensors in the system may include 2-D and 3-D cameras, location sensors, speakers, microphones, communication devices, and interfaces. The platform may be worn or attached to the user as an accessory facilitating user mobility.

This reference is deficient in the following respects: the reference is limited to devices that are communication devices; the platform is designed for personal use.

U.S. patent application publication number 2007/0242131 of Ignacio Sanz-Pastor et al published on Oct. 18, 2007 for Location Based Wireless Collaborative Environment With A Visual User interface discloses a wireless networked device incorporating a display, a video camera and a geo-location system receives geo-located data messages from a server system. Messages can be viewed by panning the device, revealing the message's real world location as icons and text overlaid on top of the camera input on the display. The user can reply to the message from her location, add data to an existing message at its original location, send new messages to other users of the system or place a message at a location for other users. World Wide Web geo-located data can be explored using the system's user interface as a browser. The server system uses the physical location of the receiving device to limit messages and data sent to each device according to range and filtering criteria, and can determine line of sight between the device and each actual message to simulate occlusion effects.

This reference is deficient in the following respects: the reference is limited to viewing information by panning the device and is restricted to a defined location.

U.S. patent application publication number 2014/0168243 of Jeffrey Huang et al published on Jun. 19, 2014 for Systems and methods for synchronizing, merging, and utilizing multiple data sets for augmented reality application are disclosed. In one example, an electronic system receives and processes live recorded video information, GPS information, map data information, and points of interest information to produce a data set comprising merged graphical and/or audio information and non-graphical and non-audio information metadata that are referenced to the same clock and timestamp information. This data set can be stored in a cloud network storage. By retaining numerical and textual values of non-graphical and non-audio information (e.g. camera viewing angle information, GPS coordinates, accelerometer values, and compass coordinates) as metadata that are referenced to the same clock and timestamp information within the data set, an augmented reality application that replays information or augments information in real time can dynamically select or change how the data set is presented in augmented reality based on dynamically-changeable user preferences.

This reference is deficient in the following respects: the reference is limited to using defined clock and timestamp information; the reference utilizes multiple data sets.

### SUMMARY OF THE INVENTION

In accordance with the invention, the problem of not having topical, relevant in formation wherever and whenever it is needed is avoided by using a server to deliver augmented reality content to the user on a device, tailoring it to the specific time, location and circumstances as needed.

### BRIEF DESCRIPTION OF THE DRAWINGS

FIG. 1 is a view of the three components of the invention comprised of software on the end-device known as a viewer, the platform that controls the viewer and queries the data warehouse, and the data warehouse, which stores the various files and data that will be used by the viewer.

FIG. 2 is a view of the end-user locating a target with the viewer and the platform providing the associated content to the viewer for display to the end-user.

FIG. 3 is a view of the gateway. The platform will have the ability to source content/data from a third-party source via a gateway and then display that content/data on the viewer.

### DETAILED DESCRIPTION OF THE INVENTION

Definitions:

Platform Controlled Augmented Reality—The combination of a server and viewer to create, manage and deliver topical augmented reality experiences wherever and whenever they are needed.

Platform—Centralized server on which content can be created and managed, and delivers the appropriate content to the viewer.

Viewer-Application—Runs on Devices of any type that includes software

### How to Make the Invention

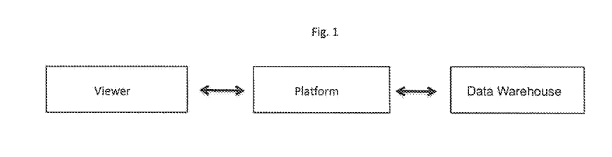

The Platform Controlled Augmented Reality is comprised of three integral parts: the viewer, platform and data warehouse (see FIG. 1)

Each of these, working in concert, provides topical augmented reality experiences to the end user.

The viewer, an application written using a programming language and executing on a mobile device, interfaces directly with the platform, residing on the Internet. The platform in turn interfaces with the data warehouse, residing on internal servers. All communication uses the communication layer.

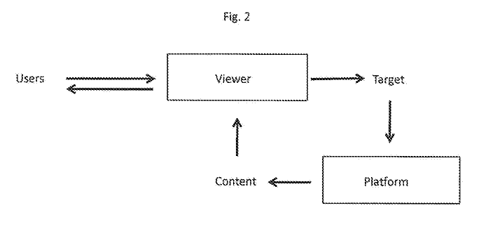

The viewer actively scans for targets, which are predefined images such as logos and other company marks; once a target is found, the viewer receives content from the platform (See FIG. 2). Content can range from simple text displays, to images, video and even animations; multiple pieces of content can be combined to create rich interactions. The complete set of content that is displayed in the viewer is called an experience. Content can be created in the platform, or it can be retrieved from external sources via gateways to other systems.

The platform delivers content to the viewer on demand and as needed, and draws on its own internal database to tailor each piece of content appropriately. The platform decides, based on configuration, which pieces of content to include based on time, location and other circumstances, then sends this content to the viewer. The platform itself can interact with external data sources via gateways if necessary, removing this burden from the viewer.

The data warehouse serves as a repository of information at a very granular level. It is used for deep analysis of the content as well as predicting what other information might be relevant to the user.

### Viewer

The viewer is available for iOS, Android, Mobile Windows, Google Glass, and other devices and is compatible with the latest version of each. The viewer will offer, within reason of the individual operating system, identical operation and display on each platform. The viewer will utilize cellular connections as well as the preferred WiFi connections, although it will be capable of operating minimally without any network connection present.

The viewer has three basic modes of operation: scan mode, content mode and option mode. A launch screen will be utilized for the viewer, along with a loading indicator.

### Scan Mode

Scan mode is the default mode for the viewer, During scan mode the viewer is actively seeking to acquire a target using the device's camera. Once a target has been recognized, the viewer will enter Content Mode. If there is any automatic content, it will be displayed during scan mode.

Upon launch, the viewer will check for default content and experiences. If such content is found, it will be automatically displayed to the end user. Once dismissed, or if there is no default content, the viewer will enter Scan Mode.

While scanning, the viewer is always attempting to recognize a target from either it's internal target database or a target database on the internet. During this mode, the viewer will be relatively unobtrusive, displaying an appropriate logo in the upper left hand corner, and minimal controls at the bottom of the screen, and will display live video from the camera. The controls will be in the livery.

When a target is acquired, the viewer will vibrate and play a sound to provide positive feedback that the target has been found. In addition, a loading indicator will appear until all content associated with the target have been completely loaded and launched.

When a target is lost, the viewer will play a short sound to provide feedback that the target is no longer active. If a target is manually dismissed, no positive confirmation will be provided.

During scan mode, buttons for options/preferences/camera will be readily available in the lower right corner. These buttons will be rendered in an appropriate color scheme.

Double tapping the screen during scan mode will load the viewer's favorite experience, provided one has been set.

Clicking the camera button will immediately take a snapshot of the screen and save it to the user's camera roll.

### Content Mode

Once a target is found, the viewer will render the appropriate content from the platform for the current target. Content can be simple overlays or complex games. Content can be persistent, expire after a set period of time, or modal, meaning it has to be completed or dismissed before the viewer goes back to scan mode.

The viewer does not contain content in and of itself, and as such is completely agnostic to the content being delivered to it. Instead, the viewer understands how to correctly render the content delivered to it, as described by the platform; the sum of the content returned makes up the rich experience for each target. For example, the platform might provide a line of text, as well as the text's font, size, color, and relative screen position. Once the viewer receives this information, it will render the text appropriately without regard to what the text actually is. Similarly, the viewer responds to images, video and other content types. By combining content together in the same response call, sophisticated end user experiences can be achieved.

In content mode, the viewer will use the brand's default colors relevant to the content's creator and/or brand it represents, thus customizing itself to the brand. Plus, all text, buttons and graphics will be rendered in the brand's colors, as defined in the platform.

The buttons available in content mode are the camera and favorite buttons, rendered in the brand's appropriate color scheme. Pressing the camera button will immediately take a picture of the screen, including any content rendered, and save it to the user's camera roll. Pressing the favorite button will save this experience as a favorite, and make it available via a double tap in Scan Mode.

### Option Mode

The viewer will allow the user to set/maintain various options, such as privacy and the user profile; this mode will only occasionally be used. Options are accessed via a small icon in the lower left hand corner on the screen during scan mode. Once pressed, the options page will be presented in the viewer.

The viewer will allow users to customize it and complete their profile as appropriate via an options setting. One option will be the opting-in of any applicable loyalty programs, which will in turn send detailed user and/or device information to the platform.

Options will exist for:
Privacy: Turning off will not send/utilize any personal data, although the unique device ID must always be sent.
Profile: The user's name, city, state and email address can be entered here
Loyalty Programs: A scrolling list of loyalty programs that the user is participating in will be displayed, along with a slider to turn participation on or off for each, along with the current point balance.
Push Notify: The option of turning off push notifications is available.
Sounds: On/Off (by default, viewer will play a sound when a target is acquired and a different sound when the target is lost)
Vibrate: On/Off (by default, viewer will vibrate when target is acquired)
Favorites: A list of select experiences will be available for the user to mark as favorites. When making an experience a favorite, the experience is preloaded. In addition, double tapping on the viewer's screen in scan mode will immediately load this experience.
Automatic Content: A list of content by brand or other topic that the user can choose to automatically run when the application launches.

### Viewer Operation

Once a target has been acquired and the target ID established, the viewer will download the targets content from the primary platform. The content itself will dictate what happens next, and will vary from target to target. The viewer, when requesting the content, will include as much information as possible in the request, including, but not limited to, items such as a device identifier (UDID), GPS coordinates, compass information, accelerometer and device resolution. This information will be used to tailor the content as appropriate to the individual user and/or location, and is a key component of the overall platform.

Once the experience is complete, the viewer will be returned to scan mode until a target is once again located. If the content is non-modal, the viewer will not return to scan mode until the content is dismissed.

The platform will utilize push notifications for significant events, such as achieving a loyalty level and/or reward.

### Viewer Caching

To improve performance, the viewer performs caching of objects whenever practical. Should an object be used that is already in the cache, the viewer will used the cached object in preference to downloading it again. Furthermore, the viewer will look ahead in the current experience to see if there are any objects of interest that might be used by the user, and download those in the background, making them available quicker.

When a viewer downloads content that is non-trivial, such as images and animation files, a unique hash is created for the content, and sent along with the content. The viewer stores the content and the hash on the device's disk, thus caching it. On subsequent calls that use the same content, the viewer checks the hash, and if it is the same uses the previously stored content from the disk. This avoids downloading duplicate content again, saving performance and allowing the viewer to be more responsive on subsequent scans of the same target. Should the hash be different, the content is downloaded with the new hash, and content and hash replace the existing content and hash on disk.

In addition, while an experience is active, the viewer places a call to the platform. This call looks at the content within the current experience, and looks for at content that the user can interact with, such as tapping. If such content exists, and leads to more content which are images, animation files or other large content, this content and its hash are downloaded in the background. This anticipated download will allow the subsequent tap to feel more responsive because the content has been pre-cached.

In addition, the viewer can optionally cache the Viewer Control File response that is returned from the platform. If the target response file can be cached on the device, a cache expiration date/time is specified, indicating the timeframe the viewer does not have to query the platform for the target response file. Even if a target response file is cached, the viewer must still respond to user input, and record taps and interactions if requested to do so.

In the event the viewer exceeds the number of allowed cached targets, the oldest target scanned will be removed from the internal cache and the new target stored. In this manner, the viewer will always maintain an internal target database of the most frequently used targets.

By caching the last content, the viewer can continue to function even if communication to the platform is unavailable.

When no internet service is available, either by cellular service or a wireless network, actions will be cached internally. Upon requesting content over a network, the cache will transferred to the platform as a one-time packet, then internally cleared once confirmed by the platform. The expected content will then load. Should significant de lays occur over this, the user will be presented with an appropriate message. In this way, out of service views are accounted for as soon as possible.

### Launch Content

The viewer will have the ability to display some content at launch. This launch content will be set in the platform using a virtual target. Launch content can only be created by authorized personnel. To create/maintain the launch content, create a virtual target with the ID of “LAUNCH”. This target is automatically polled by every viewer on start up, and if found, displayed. This content is the same as all other content, save it is automatically delivered when the application is launched by the user.

By default, the launch content will show all current brands available in the platform in a scrolling text bar at the bottom of the viewer. Tapping on a brand's name will bring up the brand's default experience, albeit with no functionality, other than a message that to see the full experience, the brand's target needs to be actually scanned. This will act as a teaser to the user, and encourage them to find/scan the appropriate targets to see the full experience. The default experience is created and maintained via the platform, allowing for changes as necessary.

The user will have the ability, via preferences, to select/customize the automatic content to suit their particular needs and tastes. In this preference, users will be able to see all automatic content available and select the one(s) of their choice. From that point forward, the content will run at launch.

### Launch Targets

The viewer, when launched, will query the platform to see If there is a new, update target database, known as launch targets. The target database contains those targets whose definitions are to be stored on the device itself, facilitating faster target recognition.

If a newer version of the target database, or launch targets, is found, this database is automatically downloaded from the platform and stored on the viewer.

The launch targets contains a definition of each target and a target identifier. The definition allows the viewer application to recognize a shape, image, logo or other distinguishable shape as a target, and associate it with a target identifier. When such a target is found, the viewer sends the target identifier along with other relevant information such as GPS coordinates, to the server and waits for a response.

Authorized users can upload new launch target databases whenever needed. In so doing, all devices will immediately recognize the new targets contained in the updated database, or stop recognizing targets no longer contained in the database.

If the viewer cannot find a target in its local launch target list, it will look for targets that are defined in another, remote, target database stored elsewhere on the internet.

### Find the Target Game

The platform includes the ability to define and control a “find the target” style game. In this game, an arbitrary number of targets are defined and specified for inclusion in the game. The object of the game is to scan a minimum number of targets and continuing after that until a winning target is found, or until all targets have been scanned, in which case the game is automatically won. Once the minimum number of targets has been reached, each subsequent scan has a chance of winning. Regardless of whether or not a target is a winning target, each target will return an appropriate experience.

The game definition includes the minimum number of targets that must be scanned before the game can be won. Until this minimum is reached, the game cannot be won.

Once the minimum number of targets has been scanned, each subsequent scan has a random chance of winning the game. This chance is defined as 100% divided by the total number of remaining targets. Thus, if there are four targets left, the chance of winning in 25% (100% divided by 4).

Once a winning scan is determined, an appropriate experience is sent to the viewer and the game is automatically reset.

### Viewer/Platform Communication

The viewer application and platform communicate using the communication layer. This layer is a standardized format which describes what data to is being passed as well as the data itself. Each discrete type of content has its own specific format; in addition, a meta format is defined for data which applies to all content within a target.

The viewer sends the current GPS coordinates of the device to the platform. In the event the user does not wish the GPS coordinates to be used or they are unavailable, the coordinates simply will not be sent. Without valid GPS coordinates, the platform is unable to provide location-specific experiences.

The viewer will send compass information, including current direction, and accelerometer information, including the current speed, if any, to the platform. The platform's communication layer receives this information from the device.

The platform uses information sent from the viewer, such as GPS Coordinates, compass and accelerometer information to further tailor and refine the content it delivers.

The platform stores all information sent to it by the device in the data warehouse, associating it with the device for later analysis.

In the event the viewer does not receive a response in a timely manner (predetermined), the viewer will resend the request, along with an additional parameter indicating this request is a resend. In the event that no request is forthcoming, the viewer will display a note to the user indicating that a target was found but could not be downloaded.

The viewer must pass same basic authentication information as part of each request. Currently, this is undefined, but using SSL as a base level security mechanism along with session cookies might prove satisfactory. The goal is to prevent the URL from being sniffed, then manually processed in a web browser, or worse yet, via an automated script. This authentication includes an internal password to verify the legitimacy of the viewer.

### Multiple Devices

It is anticipated that some users will wish to use more than one device, for example, both an iPhone and an iPad, or an Android phone and an iPad, yet still retain their information across devices. This will be accomplished via the user filling in some or all of their profile, and at a minimum their email address, to complete this association. The platform will internally track devices separately via the device ID (UDID), but will automatically merge profiles together when possible.

### Viewer Location and Privacy

All content will expect GPS coordinates, but will deliver meaningful results, even if of a more location generic nature, in the absence of GPS data. It is always in the user's best interest to allow the Viewer access to the current location, although some users will prefer a generic content due to privacy concerns. We will always respect the user's wishes.

### Platform

The platform, which is code written in a programming language, is responsible for delivering customized content to the viewer on demand. As the request for content is received via the communication layer, the platform will utilize information in the request and from the data warehouse to create and assemble the content, then send it to the viewer.

The platform is the one single repository for all target definitions and the content associated with each one. Because the viewer send the target identifier to the platform, then receives the response back, changes made on the platform are immediately reflected in all devices. Changing the target's content will on the server affects all devices, allowing a centralized system for managing content across all devices.

Authorized users will be able to create their own targets and content, as well as define how each content is delivered. Authorized users will also be able to specify the colors and graphics the viewer uses in content mode, thus customizing the viewer to their brand's look and feel.

Access to basic reporting at an experience level via the platform is available. Authorized users will, for example, be able to see how many times the content was viewed, how many taps it garnered, or how many advertisements were viewed, and subsequently tapped. All information is at a high level, and designed to give feedback that the experiences are indeed being viewed as expected. Detailed reporting and analysis is accomplished via the date warehouse functionality.

All changes by users are logged in detail, including the area that was created or modified, the date and time of the change, and the IP address. Detailed accountability is a hallmark of the platform.

It is possible that the experience file will not contain an experience, but rather the location of another, presumably local, server, to better handle the experience. Once this directive, which includes an expiration date/time is received, the viewer will request all experiences from, and store data on, the local server for that target until the expiration date/time is reached. This scenario will handle large events, such as sporting events and concerts, while maintaining a very high quality of service. Local servers will merge their content back into the main data warehouse once the event has concluded.

### Location

The location a device is at when acquiring a target can have a profound impact on the resulting experience. The platform includes locations for this purpose. Locations can be a single point on the planet, such as a specific concession stand in a specific stadium, or they can be broader areas such as the stadium itself. A location can also be a point and radius, which allows proximity to each location to be determined. It is understood that devices that have location services turned on, our preference, are not extremely precise, so some latitude must be given when defining locations.

The system defined location “Everywhere Else” is automatically available. This location is the default “location,” and is used when the viewer is not in a specific location. If an experience does not have any specific locations defined for it, then “everywhere else” is used as the location. If an experience defines a single location, and the viewer is not in that location, then “everywhere else” would be used to deliver the experience. The system-level “Everywhere else” allows the viewer to behave in an intelligent manner should the viewer be outside the locations of interest.

Districts encompass multiple locations, allowing locations to be arbitrarily grouped together.

The location or district is used by the platform to deliver a specific experience for that location. Additionally, the location experience can optionally be delivered only on specific dates and times, which is useful for sporting events, concerts, movies, and specific events. This allows the platform to deliver highly relevant experiences at the appropriate times, while still allowing appropriate experiences at all other times.

The platform has extended logic for each target, allowing for further refinement of experiences based on whether or not the user has or has not interacted with a particular target, has or has not interacted with another, different, target, or whether the user has or has not completed all or some of their profile. This logic also includes a time frame for each, and a minimum number of interactions necessary to trigger the condition.

### Targets

The viewer recognizes targets, which in turn determine the experience(s) to be loaded into the viewer. Each target has a specific and unique ID; this ID is sent to the platform and is tied to an experience. Once the platform receives a target ID, it prepares the appropriate platform control file response and sends that to the viewer for display execution.

Targets can be any image, such as a brand logo, or any other mark. Typically, targets need to have well-defined edges and features to facilitate the recognition process. Each target's individual characteristics allow it to be uniquely identified and specified with the platform.

Authorized users can add, change and deactivate targets at will via the platform. In this manner, it is possible to change a target's experience (behavior) while the target is active; this is a powerful and compelling feature of the overall platform. It is never possible to delete a target to preserve historical data.

The viewer can also recognize barcodes and QR codes as targets.

### Virtual Targets

A target can be declared as a virtual target, meaning it doesn't have a physical representation in the real world. Virtual targets are used in places such as the loyalty program to create and return content to the viewer for specific circumstances. For example, when returning loyalty award content, a virtual target is used to create this content, which the platform automatically includes when the appropriate loyally award level is reached,

Virtual targets have all the same characteristics and capabilities as regular targets, except they can be rendered without the user having to scan a physical target. The server can send the user to a virtual target upon certain actions and conditions, thus creating rich multi-step experiences.

### Content

Each target will be associated with one or more pieces of content, although the content will be customized and tailored, depending on the requesting device and/or location, and/or the time of day, including before/during/after a specific event.

When creating content, authorized users will specify basic parameters, such as the content type, including text, images, video, animations and notifications will be specified. The basic content types are generic in nature, by design, as it is the combination of content that produces the final result. For example, the content could be a logo, a menu (a floating menu of information is displayed in the viewer), or it could be a ticker (information is scrolled across the viewer), or it could be a video (a video is played in the viewer).

Each target specifies which content to deliver in which order. All content combined creates the experience for the target on the viewer. By combining content, sophisticated experiences can be created. The target's Content can be tied to a specific location, date and time, and deliver different content information based on that. This will allow the content to change in regards to the user's proximity to the event and the event's timing, and will, for example, allow exclusive content to be delivered at an event in progress.

Content is similar to single-purpose building blocks; each piece of content can be created once and used in different targets, allowing for infinite flexibility and expansion with a minimum of effort. By itself, each piece of content is a relatively simple object. By combining content, however, the brand can build a very rich environment in the viewer can be achieved.

Content types can also be used to gather input from the user, either by tapping or dragging on their device's screen. Input content is prompted for by the server; the device is responsible for rendering the content, gathering the input, and transmitting it back to the server.

The user log ins will allow them to see basic usage statistics for their content, such as the number of times the content has been retrieved. Detailed usage statistics will be compiled in the data warehouse, allowing sophisticated analysis and further customization of the content delivered.

### Gateways

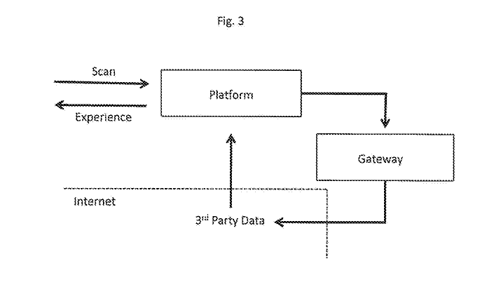

Content will have the ability to source their data from a third-party source via a gateway, which is a very powerful feature. In this manner, brands can maintain up to date information (such as current scores, wait times, flavors, etc) which the content can utilize. All content types are available for sourcing via gateways. Because the platform will be requesting this data, we maintain control over its retrieval, delivery and presentation. Text, images and video will be eligible for third party sourcing. Authorized users will create and maintain appropriate gateways for third party websites. Note that utilizing a real-time gateway may impact the overall loading/execution time (See FIG. 3).

A target can return more than one piece of content. This allows content re-use when appropriate, and allows creative usage scenarios. All content will be completely processed by the platform and will be delivered as a single response file to the viewer for performance reasons.

Gateways can be either inbound or outbound. Inbound gateways pull information from other systems outside of the platform. Outbound gateways push information to other systems outside of the platform.

### Data Warehouse

The data warehouse is a key component of the platform, and utilized during all phases of operation. Not only will the data warehouse be responsible for handling basic usage statistics, but it will also track individual devices, allowing detailed analysis of engagement.

The data warehouse will be designed around the typical star schema utilizing fact and dimension tables.

The data warehouse will not necessarily be updated in real time, since it is a data repository, but it is expected that it will update quickly after each experience. The data warehouse is expected to resides on its own database server, and is optimized for reporting, not, transactional updating. The data warehouse will be utilized by both the platform and authorized users for detailed usage statistics,

There is one central Data Warehouse which contains the sum of all information regarding users, devices, targets and experiences. However, it is also possible to run remote Data Warehouse on local platforms. Data from the remote Data Warehouses can be combined with the central Data Warehouse, providing authoritative, comprehensive data store.

### Loyalty Programs

Loyalty programs can be created to reward users for certain actions in each experience. All loyalty programs are point based, although what a point actually represents is left undefined in the platform itself. Levels are defined within the loyalty program which help users track their progress through the program.

Loyalty programs can encompass multiple point levels, with more points earning a higher level. Loyalty programs can optionally push a notification to the device of the achievement. Because experiences can be location based, and loyalty is implemented via experiences, loyalty programs can award more or less points depending on a certain time and location. Thus, it is possible to add bonus points for attending a certain event and using the viewer.

Each piece of content and each target can specify that loyalty points are awarded for viewing it. These points are awarded as the content is pushed to the viewer, and the point totals included will always reflect the current points achieved. Careful consideration must be given to the correct spot, control or target, to reward the correct actions. In addition, an optional reward interval can be specified, preventing the reward from being given within that interval. For example, if 1 day is specified for a particular target, then the points will be awarded once for every 24 hour period the target is scanned. In addition, content can specify that points are awarded upon tapping the content instead of just viewing it. Targets do not have this option.

Levels are defined as a minimum number of points to reach that level, and are used to help users understand their progress through the loyalty program. Each level has a minimum number of points, along with an optional specific award or announcement; earning the minimum number of points for the level means that the level has been achieved.

Points can be awarded from outside the platform or viewer. These will be staged and awarded to the end user on the next call to the platform. Once awarded, these points become a permanent part of the end user's total points.

Points can be pooled, or shared, between users. Pooling points is initiated by the individual user, and one or more points can be pooled with one or more users. Each user within the pool can use the full amount of points as if they were the individual's.

The platform handles all accounting and control of the pooled points, and communicates the appropriate values to the appropriate users and devices as needed.

### Miscellaneous Topics

The viewer will ask exactly one time for the user to rate/review the application, with dialog prompts for yes, no and remind me later. Answering “no” will permanently dismiss the prompt, even when new versions of the viewer are available. Remind me later will remind the user in one week to rate the app.

The user will have the ability, via options, to opt-out of the viewer collecting personal information. The viewer will explicitly respect the user's preference, although the device identifier (UDID) will always be sent, allowing the platform to correctly deliver the content. Users who opt out of personal information will not be able to be personally identified in any manner.

The user will also have an opportunity to complete or update their profile via the viewer options panel, and indicate information such as their name, gender, age, email address, and other pertinent demographic information. At no point will a password be asked for, since there is currently no need for one. Completing the user profile will allow the user to receive a more personalized experience.

In the event of a crash, a crash report can be submitted to the platform for later analysis.

The server can synchronize Augmented Reality experiences with external data sources, such as television broadcasts, radio broadcasts, podcasts and other transmission methods. This can be accomplished via a gateway, or internally to the server.

Timing and synchronization signals are used to keep the Augmented Reality Experiences coordinated with the originating broadcast.

The base language of the platform and the device is standard American English. Each user can choose, however, to utilize the platform or device in their native language. In this case, the platform or viewer delivers the appropriately translated verbiage to the user in the selected language.

Language translations are stored in a language file on the server. Once a user selects a language other than English, the appropriate verbiage is displayed instead. This language layer allows native language operation.

User can customize some types of content to allow for real time data such as stock quotations and weather, to appear on their device. Real time data is gathered and controlled by the platform, and is typically accessed via a gateway. Real time data is available at launch as desired.

Some content can be gathered from more than one data source before being presented to the user. In such cases, the platform uses one or more gateways to assemble the data into a single experience, then sends that experience to the user. The user, in turns, sees the combined data.

In addition to scanning targets, which in turn cause the server to deliver content as experiences, users can also choose which experiences to see. They do this by opening up a directory of experiences, and selecting the desired experience to view by tapping on it. Once selected, the experience will be immediately displayed to the user.

The server can manage a pre-defined directory of experiences for the user to select from.

User can save currently executing experience as a favorite, making it available to select from their directory of experiences.

The viewer has a purge button. Once pressed and confirmed, the purge button permanently and irrevocably purges and erases all data from the viewer and the platform. It is not possible to recover or utilize the data once purged.

The viewer has an illumination button. Pressing this button will turn on the device's built-in flash, or external flash should one be connected, to further illuminate the target. Because target recognition depends on the device to being able to readily discern details in the target, the illumination button allows for the viewer to operate in low light situations.

We claim:

1. A Server Controlled Augmented Reality comprising: server controller; said server to define, deliver and control augmented reality experiences; said server to define, deliver and control augmented reality experiences; said server to control pertinent content to a specific device; and said device being selected from the group consisting of: end user device, collection of devices, or other device, based on definable criteria.

2. A server controlled augmented reality according to claim 1, wherein the experiences executed on devices that run iOS (Apple), Android and derivatives such as Amazon's Kindle and Fire, Windows (Phones, tablets, surfaces and other derived software) and other such devices, including game consoles and game devices, televisions and television devices, that allows augmented reality experiences.

3. A server controlled augmented reality according to claim 1, wherein the server and data warehouse, using feedback from augmented reality experiences to further refine, customize and control subsequent augmented reality experiences; and such feedback includes usage information over time, date, location, compass, and accelerometer readings, along with user input such as taps, drags, direct data entry or other user response methods.

4. A server controlled augmented reality according to claim 1, wherein a logical system within the data warehouse uses data regarding which augmented reality experiences were utilized by the user to deliver different relevant experiences, either from the company's experiences or other, relevant companies and partners via a gateway.

5. A server controlled augmented reality according to claim 1, further comprising a logical system within the data warehouse which can determine if the user has or has not seen a particular target an arbitrary number of times within or not within an arbitrary period of time or location, or combination thereof; and said logical system can adjust the intended response accordingly, if appropriate.

6. A server controlled augmented reality according to claim 1, further comprising a logical system within the data warehouse which can determine if the user has or has not filled in all or part of their user profile, consisting of their name, email address, address and other relevant information, within a defined period of time; and said logical system can adjust the intended response accordingly.

7. A server controlled augmented reality according to claim 1 wherein a device receives information from the server regarding the type of augmented reality experience; said device, using that information, renders the experience; and said device depends on the server to provide context, content and information to properly render the entirety of the augmented reality experience.

8. A server controlled augmented reality according to claim 1, further comprising a device which actively scans for targets that it recognizes, based on a target database; said device notifies the server of the target along with relevant information such as the device ID, location, compass and accelerometer data; and said device uses the communication layer to notify the server when a target is recognized.

9. A server controlled augmented reality according to claim 1 wherein a device waits for the server to send a response via the communication layer; and said device uses the response to render the augmented reality experience or display relevant information.

10. A server controlled augmented reality according to claim 1 further comprised of formatted blocks of information based on the type of augmented reality experience, known as the communication layer; and said blocks of information are passed between the server and the device over a communications service such as WiFi, Cellular Data, or other data transmission network.

11. A server controlled augmented reality according to claim 1 further comprising targets defined on the server and recognized by the device; said targets allow the augmented reality experiences associated with the targets to be universally added or modified at the server level; and said targets are subsequently immediately available to all devices.

12. A server controlled augmented reality according to claim 1, further comprising of a database of targets; said database of targets comprised of information which uniquely identifies and defines each target; said database of targets is sent to each device as the application launches on the device; and said target database allows new targets to be recognized by all devices at any time without user intervention.

13. A server controlled augmented reality according to claim 1, further comprising a target definition, based on a unique identifier, known as a virtual target; said virtual target allows targets that do not have a physical image or representation to have content associated with them; and said virtual targets can be used to render content without the user scanning a physical target.

14. A server controlled augmented reality according to claim 1 wherein a communication layer of formatted information which defines and describes the type of content, including meta, text, image, video, animations (2D and 3D), alerts/notifications, overlay/translations, sounds and data input types; and said communication layer contains data and information which the viewer application uses to correctly display and render the content on the device.

15. A server controlled augmented reality according to claim 1 further comprising a communication layer of information including GPS coordinates, compass and accelerometer information; and said communication layer transmits the information to the server.

16. A server controlled augmented reality according to claim 1 further comprising of a communication layer on the server, said communication layer receives information from the device including GPS coordinates, compass and accelerometer information, said communication layer uses that information to further refine and control subsequent augmented reality experiences; and said communication layer stores the information in the data warehouse.

17. A server controlled augmented reality according to claim 1 further comprised of a communication layer on the server which sends the device instructions to communicate with a different server for an certain period of time; and said different server can be a large-scale publicly available server, a private server, or a personal server.

18. A server controlled augmented reality according to claim 1 wherein a gateway allows the server to source content from an outside, third party system; said gateway and server send content to the device using the communication layer; and said gateway can combine content with other, predefined static content to create rich augmented reality experiences.

19. A server controlled augmented reality according to claim 1 further comprised of control information from the server to properly render the augmented reality experience; and said control information encompasses visual appearance, the actual content, and data input, such as taps and drags, and response back to the server.

20. A server controlled augmented reality according to claim 1 wherein cached content is stored locally on the device; and said cached content can be rapidly used on subsequent uses by the device.

21. A server controlled augmented reality according to claim 1 wherein the server examines the current augmented reality experience executing on the device and fetches and stores (pre-caching) content which might be subsequently rendered.

22. A server controlled augmented reality according to claim 1 wherein events are created on the server; said events are based on time, date and optionally a GPS location or proximity to a location; and said events further refine and control augmented reality experiences on the device.

23. A server controlled augmented reality according to claim 1 wherein data in the data warehouse can be combined with information from additional, local data warehouses with information from the centralized data warehouse;

24. A server controlled augmented reality comprising: server managed loyalty and reward information for each user of a device; and said server tracks target and experience usage from the first scan of the first target for loyalty and reward purposes.

25. A server controlled augmented reality according to claim 24 wherein a loyalty and reward program is managed for a specific user on a server, regardless of how many devices that each user has and/or uses; and said server aggregates loyalty information across all user devices for each user.

26. A server controlled augmented reality according to claim 24 further comprised of a loyalty and reward program that delivers, tailors, refines and controls the augmented reality experiences and content users see on their devices.

27. A server controlled augmented reality according to claim 24 further comprised of a specific number of points are awarded to users for specific activities, such as viewing or responding to an augmented reality experience or other data on their device.

28. A server controlled augmented reality according to claim 24 further comprised of loyalty levels; said loyalty levels are defined by a specific number of points; and said loyalty levels can be used to provide additional rewards or incentives as the user advances through the levels.

29. A server controlled augmented reality according to claim 24 further comprised of point management tools that allow for point pooling and point sharing; and said point management tools allow two or more users to combine, share and distribute their loyalty points, as they desire.

30. A server controlled augmented reality comprising: additional server controlled features; said features being a game defined on and controlled by the server; said game requires the user to locate a specific target to earn a specific reward; said game targets which are not winning targets provide augmented reality experiences which encourage the user to continue; and said targets which are winning provide an augmented reality experience which rewards the user.

31. A server controlled augmented reality according to claim 30 wherein the server is capable of synchronizing augmented reality experiences with an external data source, such as a television broadcast, radio broadcast, podcast, or other transmission mediums; and said server uses timing and synchronization methods.

32. A server controlled augmented reality according to claim 30 wherein language layer comprised of words that allow the device and platform to be multi-lingual; said language layer operates in the user's native language as desired.

33. A server controlled augmented reality according to claim 30 wherein user customizations allow the user to customize their experiences by choosing real-time data to appear on their device, said customizations are gathered by the server via a gateway; and said customizations are available at launch.

34. A server controlled augmented reality according to claim 30 further comprised of multi-owner experiences, comprised of data from two or more outside sources, that can be customized by the end user.

35. A server controlled augmented reality according to claim 30 wherein a tap selection system exists on the device; said selection system is comprised of a directory of experiences and taps by the user; and said selection system allows the user to choose experiences via a tap from a listing of available experiences, in addition to scanning a target.

36. A server controlled augmented reality according to claim 30 wherein an input system exists on the device; said input system is comprised of input content types which ask for user input, either through text or voice entry; said input system transmits input back to the server for further processing and analysis; and said input can be exported outside of the platform via an outbound gateway.

37. A server controlled augmented reality according to claim 30 wherein a data purge tool allows the end user to purging and erase all of their data, both on the platform and the device; and said data purge tool completely and irrevocably removes user's information from the device and the platform.

38. A server controlled augmented reality according to claim 30 wherein an integrated target illumination system comprised of the device's flash is capable of further illuminating targets; and said illumination system increases the target scan recognition.
